(19) United States
(12) Patent Application Publication
(10) Pub. No.: US 2026/0157357 A1
(43) Pub. Date: Jun. 11, 2026

(54) Rotating Attachment Component for a Wire Frame Fishing Lure

(71) Applicant: Nathaniel Bogan, Natick, MA (US)

(72) Inventor: Nathaniel Bogan, Natick, MA (US)

(21) Appl. No.: 18/705,673

(22) PCT Filed: Oct. 31, 2022
(86) PCT No.: PCT/US2022/048378

§ 371 Date: Apr. 29, 2024

Related U.S. Application Data
(60) Provisional application No. 63/273,632, filed on Oct. 29, 2021.

(51) Int. Cl. A01K 91/04

(52) U.S. Cl. CPC A01K 91/04

(57) ABSTRACT

A novel attachment component for a fishing lure that reduces or eliminates issues related to the fishing line wrapping around the lure and a fishing lure comprising the novel attachment component.

### CROSS-REFERENCE TO RELATED APPLICATIONS

The following application claims benefit of U.S. Provisional Application No. 63/273,632, filed Oct. 29, 2021 which is hereby incorporated by reference in its entirety.

### BACKGROUND

Wire frame lures (or baits) include spinnerbaits, buzzbaits, baitballs, and the lures described in PCT application PCT/US 2021/070845 filed Jul. 8, 2021. Traditionally, these baits offer one of two ways to connect a fishing line to a wire frame bait: a closed or twist eye (FIG. 1, “1”) or an open eye or R bend (FIG. 2, “2”).

A closed eye literally means that the attachment loop is closed, just like “closed” means in geometry. A closed eye is sometimes called a twist eye because the most common way to form a closed eye is to twist the wire so that the loop is closed. The principal advantage of a closed eye is that the attached line (or snap or leader) cannot slide onto the wire arms. This leads to additional specific advantages:
a. Holds snaps and/or leaders reliably in the right place.
b. Difficult to break. This is mainly because the eye itself will not bend open, but also because the line doesn't get leverage on the eye by moving up the wire arm.

As demonstrated by FIG. 3, the principal disadvantage of a closed eye is that if the line 3 wraps around the Z axis 4, which is relatively common when casting, the line remains wrapped until the angler retrieves the lure and unwraps the line. Wrapped line is at risk of being cut by the wire itself and can adversely affect the lure's operation.

An open eye is not fully closed—there is some gap, usually at the opposite side from where the line is attached. An open eye is sometimes called an R-Bend because the most popular form of an open eye includes a second bend to make it (slightly) harder for the line to slide onto the upper arm, and these bends form a shape like an R. While open eyes work very poorly for anglers using a snap or steel leader because open eyes generally require a direct connection to the fishing line, an open eye has one subtle but very significant advantage: If the line wraps around the Z axis, the line is able to simply slide through the gap and pull itself straight again, thus self-correcting any wrapping. This advantage is so significant that many anglers who do not require a steel leader prefer to use an open eye for wire frame baits. However, this significantly reduces the strength of the bait, because the wire can bend entirely open near the eye—i.e. the (intentional) small gap can be opened into a (unwanted) large gap. Repeatedly bending and unbending wire leads to a severe loss of strength and eventually breakage.

There is a need for a novel method of attaching the fishing line to the bait that offers the advantages of both the closed and open eye methods described above.

### BRIEF DESCRIPTION OF THE DRAWINGS

FIG. 1 depicts an example of a prior art “closed” or “twist” eye.

FIG. 2 depicts an example of a prior art “open” eye or “R bend.”

FIG. 3 depicts a fishing line wrapped around the z axis of a bait using a closed eye.

FIG. 4 depicts a side view of a Rotating Attachment Component (“RAC”) according to the present disclosure.

FIG. 5, depicts the RAC of FIG. 4 rotated 180 degrees around the wire frame with respect to its orientation in FIG. 4

FIG. 6 is an end on view of the RAC of FIG. 4.

FIG. 7 is an alternate view of the RAC of FIG. 4.

FIG. 8 is an alternate view of the RAC of FIG. 4.

FIG. 9 is an alternate view of the RAC of FIG. 4.

FIG. 10 shows an RAC of the present disclosure wherein the end of the wire frame aligns with the point of attachment of the RAC to the fishing line.

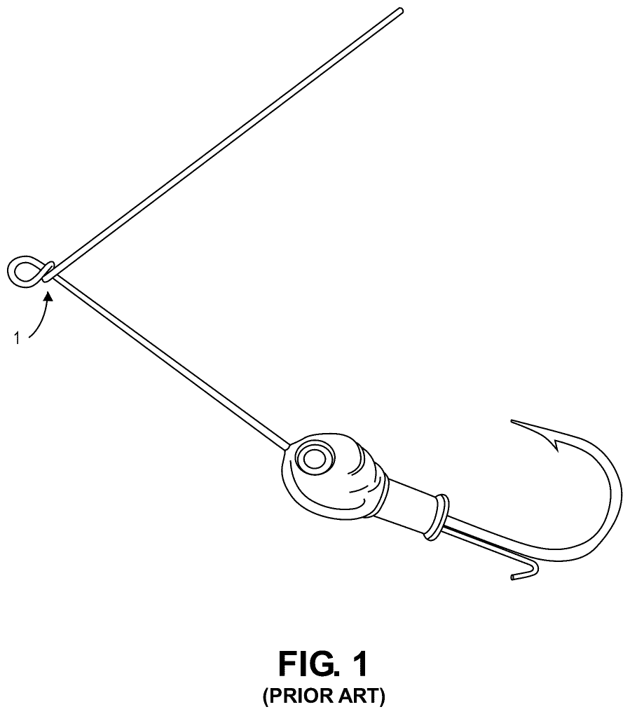

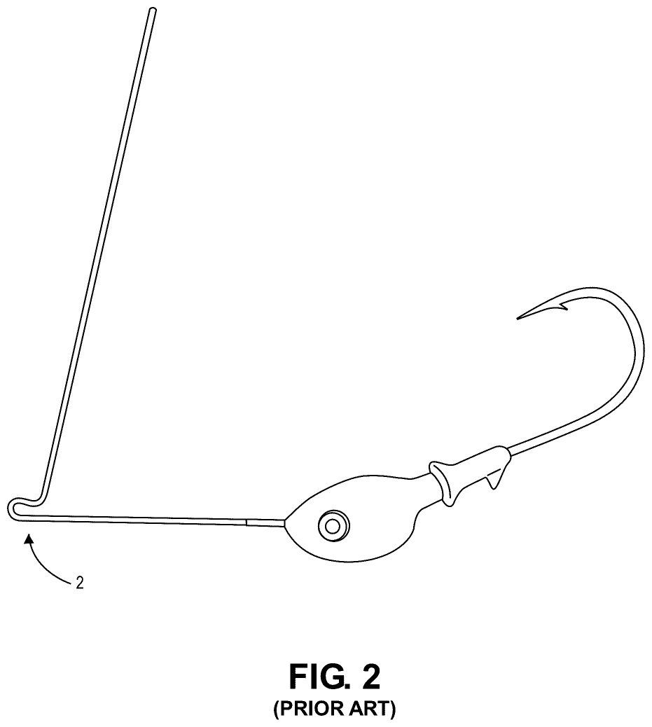

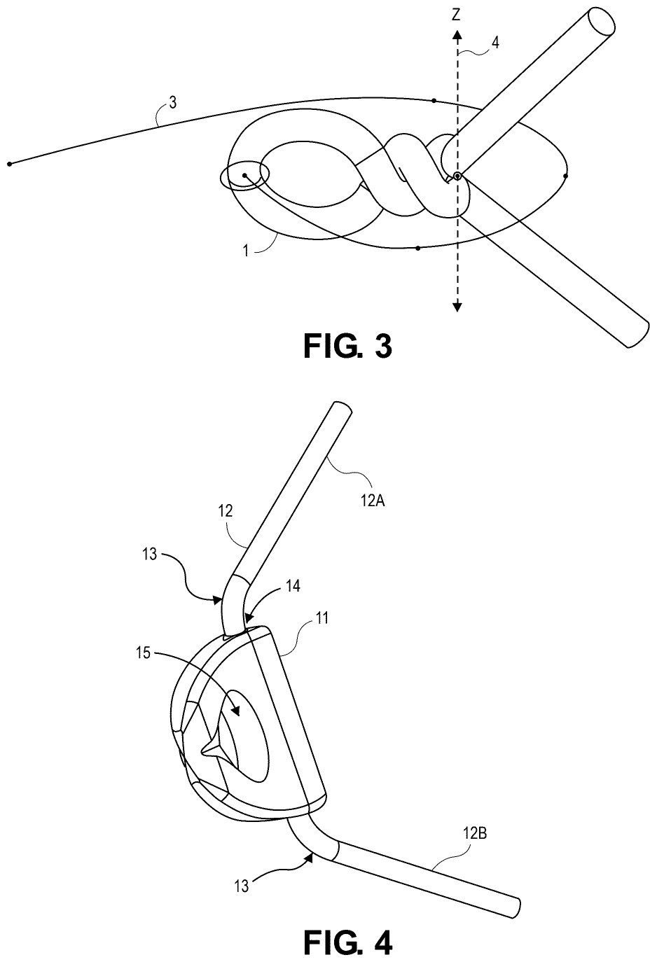

### DETAILED DESCRIPTION

According to various embodiments, the present disclosure provides a novel method and apparatus for attaching a fishing line to bait. This novel apparatus is referred to herein as the “Rotating Attachment Component” or “RAC”. For ease of understanding it may be helpful to define some terms when it comes to various components of apparatus used for fishing, as various terms can be used by anglers to mean different things (for example, the terms lure and bait are often used interchangeable, but may also be used to refer to specific (and different) things. Accordingly, for the purposes of the present disclosure, the following terms are defined as follows:
Lure/bait: all of what is attached at the end of the fishing line to attract, induce-to-bite, and hook the fish.
(Fishing) Line: the relatively limp “thin connector” that connects the lure to the rod and reel. Most commonly made from nylon monofilament or braided plastic fibers, such as those sold by Honeywell under the Spectra trademark.
“Wire leader.” A strong but somewhat limp “thin connector” that is sometimes used between the line and lure to prevent sharp-toothed fish from severing the connection. Most commonly made from soft steel, and typically of diameter similar to the line.
“Wire frame.” A relatively stiff “thin connector” that connects various components within a lure to maintain their relative orientation. Most commonly made of hardened steel, and typically of diameter larger than line or wire leader.
z-axis: the direction of gravity when the bait is operating as intended. But the z axis of the bait moves with it when it rotates, such as in the somewhat uncontrolled manner of a cast.
Rotating Attachment Component (“RAC”): A component that enables attachment of the line to the wire frame and which is able to rotate at least 360 degrees around one axis of the lure, wherein the axis is viewed as roughly perpendicular to (not parallel to) the direction of the line, so as to prevent or alleviate entanglement of the line around the lure.

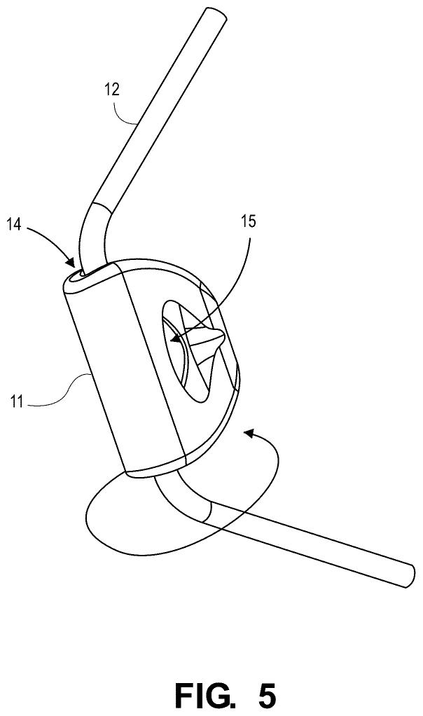

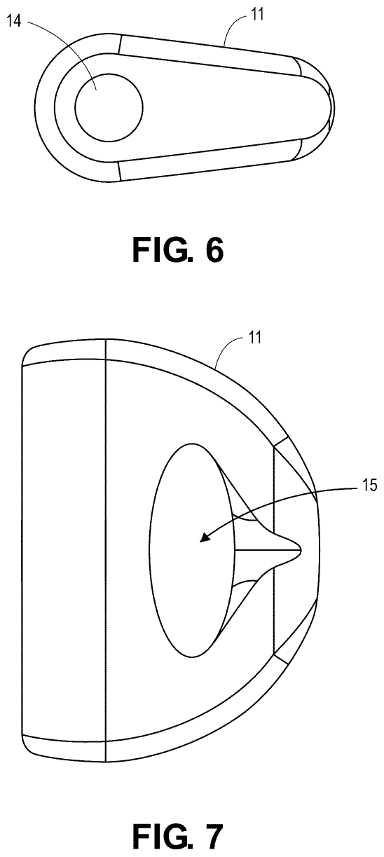

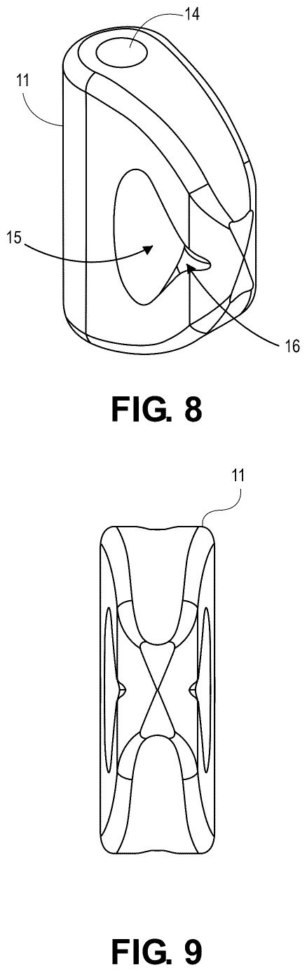

FIGS. 4-5 show an exemplary embodiment of the present disclosed RAC. FIG. 4 depicts a RAC 11 with a wire frame 12 running through it such that ends 12A and 12B extend out of the RAC. In use, the wire frame may have one or more bodies, weights, hooks, or other components attached at either end. The RAC may be formed from any suitable material including plastic, metal, a composite, etc.. In FIG. 5, the RAC has rotated 180 degrees with respect to its orientation in FIG. 4. As shown in FIGS. 6-9 the RAC is a connector comprising a lengthwise channel 14 (seen best in FIGS. 6 and 8) through which wire frame 12 is threaded (FIGS. 4 and 5) such that the RAC can freely rotate around the wire (arrows in FIGS. 4 and 5, comparing FIGS. 4 and 5). The RAC may also include an orifice 15 (FIGS. 4, 5, 7, 8) through which the fishing line may be threaded and tied or otherwise secured, thereby attaching the line to the RAC. The depicted RAC is generally D-shaped, but it should be understood that the RAC may take other shapes such as, for example, a U-shape (such as a clevis) wherein the orifice is formed by the combination of the RAC and the portion of the wire frame the clevis is secured to. Moreover, the orifice may be offset from the center of the RAC creating, for example, a “d” “b” “p” or “q” shape. This orifice (whether formed as part of the rotating component or formed by a combination of the rotating component and the wire) may further include a notch 16, which may receive and secure the fishing line in place. To prevent the RAC from sliding along the length or the wire, bends 13 in the wire and/or added discs or beads may be used, either affixed to the wire or also able to rotate around it. The fishing line is attached to the RAC with a closed attachment point, offering all of the advantages of the closed eye. However, unlike the closed eye, the RAC can rotate around the wire (for example to position shown in FIG. 5), allowing the bait to self-correct when the line gets wrapped around it, offering the advantages of an open eye.

FIG. 6 offers an end view of the RAC. In this particular embodiment, the ends of the RAC are identical. FIGS. 7-9 offer detailed rotated side views of the RAC.

As stated above, the RAC need not necessarily have the exact shape shown in FIGS. 4-9. In general, the RAC should have an attachment point for the fishing line, which may or may not take the form of the orifice described above, at least one channel through which the wire can be fitted, and a shape which enables the RAC to rotate freely about the wire. Similarly, the wire need not have the specific shape shown in FIGS. 4 and 5 (or the relative depicted proportions). Moreover, while the wire in the depicted example is showing as having bends 13, it will be understood that the RAC as a whole should have some mechanism for preventing the RAC from moving/sliding substantially up or down the wire, but that such mechanism is not limited to the depicted wire bends or the presence of the previously described bends or other items positioned on the wire, but could take the form of a design element of the RAC itself. For example, the wire may include a circular groove which matches a circular ridge inside the eye to keep the RAC from slipping. Of course, as depicted, the RAC may be given some ability to travel on the wire, but such ability should be limited at least sufficiently to prevent the RAC from physically engaging with any other components attached to the wire (bodies, weights, hooks, other components, etc.) Moreover, as in the depicted embodiment, the RAC may have a generally tapered shape wherein the broadest aspect of the RAC is the portion that contacts the wire and the RAC generally narrows (or tapers) as it extends away from the wire so as to limit any engagement/tangling of the fishing line with any attachments to the wires.

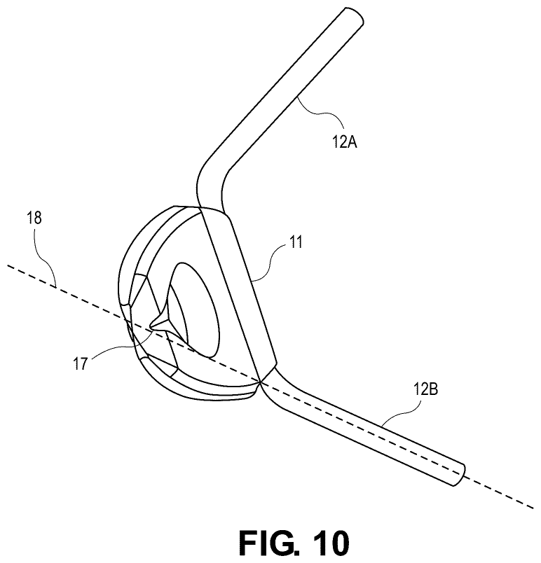

Moreover, as shown in FIG. 10, the RAC may be shaped such that the point of attachment (17) of the fishing line to the RAC is aligned with the bottom straight portion of the wire frame (12B) as shown by dotted line 18. This arrangement reduces or eliminates torque applied by a fish when biting or hooked on the lure that might result in the opening of the two sides of the wire frame.

The specific methods and apparatus described herein are representative of preferred embodiments and are exemplary and not intended as limitations on the scope of the invention. Other objects, aspects, and embodiments will occur to those skilled in the art upon consideration of this specification and are encompassed within the spirit of the invention as defined by the scope of the claims. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. The methods and processes illustratively described herein suitably may be practiced in differing orders of steps, and that they are not necessarily restricted to the orders of steps indicated herein or in the claims.

What is claimed is:

1. A mechanism for attaching a fishing line to a lure comprising:
a rotating attachment component (“RAC”) comprising:
a body having a lengthwise channel configured to receive a wire frame wherein when the wire frame is received by the RAC, the RAC is free to rotate at least 360 degrees around the wire frame but is limited in its ability to travel up and down the length of the wire frame; and
an orifice configured to receive the fishing line.

2. The mechanism of claim 1 wherein the orifice is notched so as to secure the fishing line.

3. The mechanism of claim 1 wherein the orifice is formed within the body of the RAC.

4. The mechanism of claim 3 wherein the body is D, d, b, q, or p shaped.

5. The mechanism of claim 1 wherein the orifice is formed when a wire frame is received by the RAC y a combination of the body of the RAC and the wire frame.

6. The mechanism of claim 1 wherein the overall shape of the RAC tapers as it extends away from the lengthwise channel.

7. The mechanism of claim 1 wherein the orifice is offset from the center of the RAC.

8. A fishing lure comprising:
a Rotating Attachment Component (“RAC”) comprising a body having a lengthwise channel and an orifice; and
a wire frame disposed through the channel wherein the RAC is free to rotate at least 360 degrees around the wire frame but is limited in its ability to travel up and down the length of the wire frame.

9. The fishing lure of claim 7 wherein the wire frame is bent on either side of the RAC so as to limit travel of the RAC up and down the length of the wire frame.

10. The fishing lure of claim 7 wherein the wire frame comprises one or more beads which limits the travel of the RAC up and down the length of the wire frame.

11. The fishing lure of claim 9 wherein the beads are able to rotate around the wire frame.

12. The fishing lure of claim 8 wherein the orifice is notched so as to secure the fishing line.

13. The fishing lure of claim 8 wherein the orifice is formed within the body of the RAC.

14. The fishing lure of claim 13 wherein the body is D, d, b, q, or p shaped.

15. The fishing lure of claim 8 wherein the orifice is formed by a combination of the body of the RAC and the wire frame.

16. The fishing lure of claim 8 wherein the overall shape of the RAC tapers as it extends away from the wire.

17. The fishing lure of claim 8 wherein the orifice is offset from the center of the RAC.

18. The fishing lure of claim 9 wherein the RAC includes an attachment point for a fishing line and a bent portion of the wire frame extends along a line that is aligned with the attachment point.

19. The fishing lure of claim 9 wherein the RAC includes an attachment point for a fishing line and a bent portion of the wire frame extends along a line that is offset from the attachment point.
